(19) United States
(12) Patent Application Publication
(10) Pub. No.: US 2011/0190969 A1
(43) Pub. Date: Aug. 4, 2011

(54) METHOD FOR CONTROLLING AND/OR REGULATING AT LEAST ONE PARTIAL LOAD TRANSFER IN A HYBRID DRIVE ARRANGEMENT

(75) Inventors: Notker Amann, Friedrichshafen (DE); Christian Mittelberger, Ravensburg (DE); Johannes Kaltenbach, Friedrichshafen (DE)

(73) Assignee: ZF Friedrichshafen AG, Friedrichshafen (DE)

(21) Appl. No.: 12/747,140

(22) PCT Filed: Dec. 1, 2008
(86) PCT No.: PCT/EP08/66490

§ 371 Date: Oct. 28, 2010

(30) Foreign Application Priority Data
Dec. 10, 2007 (DE) 10 2007 055 740.1

(51) Int. Cl. B60W 20/00; B60W 10/06; B60W 10/08

(52) U.S. Cl. 701/22

(57) ABSTRACT

The invention relates to a method for controlling and/or regulating at least one partial load transfer in a hybrid drive arrangement of a motor vehicle. According to said method, a driver's desired torque (M_{Driver}) is applied by at least one electric motor and by an internal combustion engine and the torque (M_{EM}) that is to be applied by the electric motor and the torque (M_{VM}) that is to be applied by the internal combustion engine are controlled using overlapping functions.

The present translation concerns a method for controlling and/or regulating at least a partial load assumption with a hybrid drive assembly of a motor vehicle according to the type further specified in the preamble of Claim 1.

Methods for controlling and/or regulating a partial load assumption with a hybrid drive assembly of a motor vehicle are known in automotive technology. These methods are used in hybrid motor vehicles that usually comprise a combustion engine, an electric machine and at least a clutch, as well as a transmission. In the known method, purely electric driving is changed to hybrid driving. In the process, the load assumption or the partial load assumption is transferred from the electric machine to a combination of electric machine and combustion engine. The known method performs a sudden load assumption. Because of the different dynamics of the electric machine and the combustion engine, the suddenly performed load assumption has resulted in knocking noises in the drive train. Consequently, the driver notices the load assumption, resulting in reduced driving comfort.

The present invention is based on the objective to propose a method of the type described above which allows at least for a load assumption or a partial load assumption without reducing the driving comfort.

Accordingly, provision has been made for a method of controlling and/or regulating at least a partial load assumption with a hybrid drive assembly of a motor vehicle in which a torque desired by the driver is applied by at least an electric machine, as well as a combustion engine, and in which the torque to be applied by the electric machine and the torque to be applied by the combustion engine are controlled by means of overlapping functions. This means, for example, that the electric machine is controlled by a hybrid control device in such a way that the torque of the electric machine is reduced to a desired target torque. At the same time, the combustion engine is, for example, also controlled by means of the hybrid control device in such a way that altogether the torque desired by the driver is achieved. It is possible to specify the target torque of the combustion engine by a strategic torque distribution of the hybrid control device. By means of the overlapping actuation of the electric machine and the combustion engine it is possible to prevent knocking noises in the drive train, considerably increasing the driving comfort with the invention-based method. This is achieved by eliminating jumps in the torque curves.

In the context of a possible design variant of the invention, provision can be made for adjusting each required torque of the electric machine and the combustion engine by means of a gradient controlled ramp function or the like. Preferably, the respectively overlapping ramp functions can have a gradient that differs merely with regard to its algebraic sign. However, it is possible to use with regard to the amount different gradients for both ramp functions.

Another design variant of the present invention can provide that, instead of gradient-based ramp functions, time-controlled ramp functions are used in order to actuate the respective torque curves of the electric machine and the combustion engine in the load assumption. In this design variant, “overlapping” means that the ramp function reaches its target torques for the load assumption within the same time interval. It is also possible to use different control systems in order to achieve at least a partial load assumption from the electric machine to the combustion engine.

Since the ramp functions involve only small changes during the torque curves, the different dynamics of the electric machine and the combustion engine result in only small deviations. As a result, the driver will hardly notice the change in drive system.

Independent of the respective design variant, provision can be made that the initial torque of the electric machine, which usually corresponds to the torque desired by the driver, is reduced to a preset target torque by means of the selected ramp function. If only the combustion engine is to be used as power unit, the target torque of the electric machine can be reduced to the value zero. It is also possible to use different values for the target torque.

Independent of the respective design variant, provision can also be made that the initial torque of the combustion engine is increased by means of the ramp function to a preset target torque of the combustion engine. It is possible that the initial torque of the combustion engine does not assume the value zero but any other value which is then used as starting value.

According to a further development of the invention, provision can be made that the sum of the torque of the electric machine and the torque of the combustion engine, each of which are determined from the ramp functions, corresponds approximately to the torque desired by the driver. Preferably this can be achieved in that only one ramp function is preset and that the second ramp function is calculated from the first.

Preferably, the hybrid drive assembly suggested by this invention and the suggested method can be used in parallel hybrid drive systems, for example, for city buses, distribution trucks and delivery vans. There are even other areas of application. In addition, it is possible that the method could involve even several electric machines.

The subsequent drawings will describe the invention in more detail. It is shown:

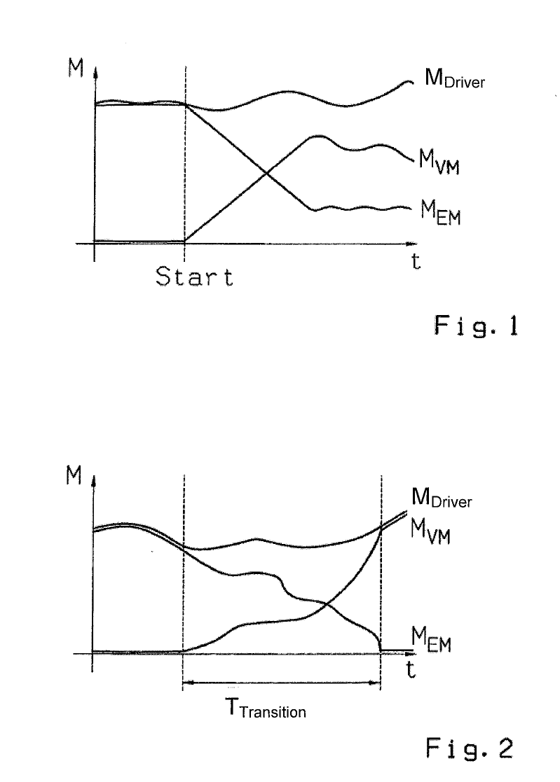

FIG. 1 a diagram with several torque curves in a load transition performed by gradient-controlled ramp functions according to a first design variant of the invention-based method; and

FIG. 2 a further diagram with several torque curves in a load transition performed by time-controlled ramp functions according to a second design variant of the invention-based method.

For example, the method provides a possibility to perform in a fast and convenient manner a partial load assumption from the electric machine to the combustion engine. In this way, a switch is made from a purely electric drive to a hybrid drive. However, by means of this method it is also possible to perform a complete load assumption so that a switch is made from a purely electric drive to a pure combustion-engine drive.

According to the invention, provision has been made that the torque required by the electric machine M_{EM} and the torque required by the combustion engine M_{VM} are controlled by means of overlapping functions. In this way, the load assumption can be performed conveniently, without the driver noticing the change in driving system.

According to FIG. 1, in the load assumption or partial load assumption, the torque required by the electric machine M_{EM} and the torque required by the combustion engine M_{VM} each are adjusted with a gradient-controlled ramp function. Before the start of the load assumption, the torque of the electric machine M_{EM} corresponds to the torque desired by the driver M_{Driver} and the torque of the combustion engine M_{VM} has the value zero. At the start of the load assumption, the curve of the torque of the electric machine M_{EM} and the curve of the torque of the combustion engine M_{VM} are adjusted by means of preset gradients, whereas in the design variant shown in FIG. 1 gradients with inverse slopes are used for the ramp functions.

At the end of the partial load assumption, the sum of the torque value of the electric machine M_{EM} and the torque value of the combustion engine M_{VM} corresponds to the torque desired by the driver M_{Driver}. Consequently, the motor vehicle is powered partially by the electric machine and partially by the combustion engine.

FIG. 2 shows a diagram with time-controlled ramp functions in accordance with a second design variant. Even in this design variant, the torque of the electric machine before the start of the load assumption corresponds to the torque desired by the driver M_{Driver}, and the torque of the combustion engine M_{VM} has a value of approximately zero. At the start of the load assumption, the curve of the torque of the electric machine M_{EM} and the curve of the torque of the combustion engine M_{VM} are controlled in such a way that the transition is performed within a preset time interval T_{Transition}. At the end of the time interval T_{Transition}, the change in drive system has taken place in which the combustion engine applies almost the torque desired by the driver and the electric machine applies only a small or no portion of the torque desired by the driver M_{Driver}. However, the distribution of the torque of the electric machine M_{EM} and the torque of the combustion engine M_{VM} has been selected only for the purpose of providing an example. It is also possible to use different distributions.

### REFERENCE SIGNS

M_{EM} torque of the electric machine
M_{VM} torque of the combustion engine
M_{Driver} torque desired by the driver
T_{Transition} time interval for the load assumption

1. A method for controlling and/or regulating at least a partial load assumption with a hybrid drive assembly of a motor vehicle in which a torque desired by the driver (M_{Driver}) is applied by both, at least one electric machine and one combustion engine, characterized in that the torque to be applied by the electric machine (M_{EM}) and the torque to be applied by the combustion engine (M_{VM}) are controlled by means of overlapping functions.

2. A method according to claim 1, characterized in that the torque to be applied by the electric machine (M_{EM}) and the torque to be applied by the combustion engine (M_{VM}) each are adjusted with a gradient-controlled ramp function.

3. A method according to claim 1, characterized in that the torque to be applied by the electric machine (M_{EM}) and the torque to be applied by the combustion engine (M_{VM}) each are adjusted with a time-controlled ramp function.

4. A method according to claim 3, characterized in that the load assumption in the time-controlled ramp functions is restricted through a preset time interval T_{Transition}.

5. A method according to claim 2, characterized in that the initial torque of the electric machine (M_{EM}), which usually corresponds to the torque desired by the driver (M_{Driver}), is guided by means of the ramp function to a preset target torque of the electric machine.

6. A method according to claim 2, characterized in that the initial torque of the combustion engine (M_{VM}) is guided by means of the ramp function to a preset target torque of the combustion engine.

7. A method according to claim 2, characterized in that the torque of the electric machine (M_{EM}) and the torque of the combustion engine (M_{VM}), which are determined from the respective ramp functions, are selected in such a way that the sum from the torque of the electric machine (M_{EM}) and the torque of the combustion engine (M_{VM}) corresponds approximately to the torque desired by the driver (M_{Driver}).
